(19) United States
(12) Patent Application Publication
(10) Pub. No.: US 2003/0022029 A1
(43) Pub. Date: Jan. 30, 2003

(54) Surface coated sintered alloy member

(75) Inventors: Hiroyuki Kidama, Kawasaki-shi (JP); Nobukazu Yoshikawa, Kawasaki-shi (JP); Itsuo Yazaki, Kawasaki-shi (JP)

Correspondence Address: FOLEY & LARDNER, 3000 K Street, N.W., Suite 500, Washington, DC, 20007-5109, US

(73) Assignee: TOSHIBA TUNGALOY CO., LTD.

(21) Appl. No.: 09/826,803

(22) Filed: Apr. 6, 2001

(51) Int. Cl. B32B 9/00

(52) U.S. Cl. 428/701; 428/699

(57) ABSTRACT

There are disclosed a surface coated sintered alloy member having a hard film coated on a base material of a sintered alloy of a cemented carbide or cermet, wherein the hard film comprises at least one Ti-containing layer which comprises at least one material selected from the group consisting of TiC, TiN, TiCN, TiCO, TiNO, TiCNO, a composite nitride, carbonitride, nitroxide, carboxide or carbonitroxide each containing Ti and Al, and the uppermost Ti-containing layer has a maximum surface roughness Rmax of 0.6 μm or less and an average surface roughness Ra of 0.2 μm or less in the reference length of 5 μm under conditions without being subjected to machining; and a surface coated sintered alloy member further comprising an aluminum oxide layer formed on the surface of the Ti-containing layer.

### BACKGROUND OF THE INVENTION

1. Field of the invention

The present invention relates to a surface coated sintered alloy member in which a hard film of a titanium compound having a smooth surface roughness is coated on a substrate of a sintered alloy, and to a surface coated sintered alloy member in which, as an intermediate layer, a hard film of a titanium compound having a smooth surface roughness is formed and an outer layer of aluminum oxide having a smooth surface roughness is coated on the surface of the intermediate layer.

2. Prior art

Sintered alloys such as cemented carbides or cermets have been conventionally used as a cutting tool. As the cutting conditions become severe, a surface coated sintered alloy with a hard film of ceramics such as titanium carbide, titanium nitride, titanium carbonitride, or alumina has been the mainstream of cutting tools.

Since a hard film on the surface of a sintered alloy has a significant influence on abrasion resistance of the tool, when the hard film is formed on the sintered alloy, various modifications and improvements are performed. Specifically, following the coating of titanium carbide, titanium nitride, alumina or the like by a CVD process, a surface treatment such as lapping of the surface portion of the hard film is carried out. Typical examples of such a surface treatment in which the surface of a hard film is processed by mechanical polishing are described in Japanese Patent Application Laid-Open No. 228305/1987 and Japanese Patent Application Laid-Open No. 108253/1994. Further, a typical example relating to the surface roughness of the substrate includes Japanese Patent Application Laid-Open No. 63604/1992, and a typical example of controlling a roughness of the interface between a titanium compound-reinforced layer and an oxide layer mainly containing aluminum oxide includes Japanese Patent Application Laid-Open No. 229144/1999.

In these publications which relate to the surface roughness of a hard film, Japanese Patent Application Laid-Opens No. 228305/1987 and No. 108253/1994 disclose that the surface roughness is improved by mechanically polishing the surface of the hard film.

However, the hard film coated alloy disclosed in the publications has a problem that the thickness of an aluminum oxide layer is decreased so that the tool life varies. Also, Japanese Patent Application Laid-Open No. 63604/1992 discloses that the surface roughness of a cemented carbide substrate before coating is set to 0.2 μm or less. However, even if the substrate disclosed in the publication is extremely smooth, the surface roughness of the hard film changes significantly according to coating conditions. Thus, when the material is used as a cutting tool, a problem arises that-the chipping resistance varies under cutting conditions particularly in a region of high speed feeding. Further, the above-mentioned Japanese Patent Application Laid-Open No. 229144/1999 discloses a coated tool in which the difference between depressions and projections at the interface between an oxide layer mainly containing aluminum oxide and the adjacent reinforced layer is increased so that adhesive properties of the oxide layer are enhanced. However, the coated tool disclosed in this publication has a problem that when the difference between the depressions and projections is very great and the oxide layer is thin, the depressions and the projections themselves directly influence on the surface roughness of the oxide layer and the surface roughness becomes large, which leads to a poor chipping resistance in a cutting region at high speed feeding, which relates to an object of the present invention. In a conventional method, the surface roughness has been improved by machining. In that case, however, thickness of a polished coated-film, particularly of the aluminum oxide film varies largely, which causes variations in tool lives. Additionally, an aluminum oxide coated tool has a problem that there is no proper requirement for the surface roughness of an inner layer of the aluminum oxide hard film, and that the tool life is short.

### SUMMARY OF THE INVENTION

An object of the present invention is to solve the above-mentioned conventional problems and to provide a surface coated sintered alloy member which has an improved chipping resistance in a cutting region of a high speed feeding when used as a cutting tool.

The present inventors noted that when the surface roughness of the coating film of the cutting tool is large, friction coefficient between the cutting tool and a material to be cut becomes large. Accordingly, cutting friction also becomes large, which is one of the causes that lead to chipping in cutting at a high speed feeding.

There is a case where a flat and smooth coating surface is obtained by preparing a flat and smooth surface of the cemented carbide substrate material by machining. However, in most cases, there is little correlation between the surface roughness of the substrate and that of the coating film, depending on the compositions and structures of the coating film to be formed.

The present inventors have carried out various experiments with a view toward solving these problems. As a result, they have found that the chipping resistance in the region of high speed feeding cutting was enhanced, by coating a surface of the sintered alloy substrate with a titanium-containing layer with a smooth surface obtained by controlling coating conditions for the titanium-containing layer, and by forming a smooth aluminum oxide layer on the surface of the titanium-containing layer by also controlling the coating conditions for the aluminum oxide layer, thereby preparing a hard film with a very smooth surface. Thus, the present invention has been completed.

That is, the first embodiment of the present invention relates to a surface coated sintered alloy member having a hard film coated on a base material of a sintered alloy selected from a cemented carbide and cermet, wherein the hard film comprises at least one titanium-containing layer and the respective titanium-containing layers comprise at least one material selected from the group consisting of titanium carbide, titanium nitride, titanium carbonitride, titanium carboxide, titanium nitroxide, titanium carbonitroxide, a composite nitride containing titanium and aluminum, a composite carbonitride containing titanium and aluminum, a composite nitroxide containing titanium and aluminum, a composite carboxide containing titanium and aluminum, and a composite carbonitroxide containing titanium and aluminum, and the outermost titanium-containing layer has a smooth surface with a maximum surface roughness Rmax of 0.6 μm or less and an average surface roughness Ra of 0.2 μm or less in a reference length of 5 μm under conditions without being subjected to machining.

The second embodiment of the present invention relates to a surface coated sintered alloy member having a hard film coated on a base material of a sintered alloy selected from a cemented carbide and cermet, wherein the hard film comprises (1) at least one titanium-containing layer the respective layers comprise at least one material selected from the group consisting of titanium carbide, titanium nitride, titanium carbonitride, titanium carboxide, titanium nitroxide, titanium carbonitroxide, a composite nitride containing titanium and aluminum, a composite carbonitride containing titanium and aluminum, a composite nitroxide containing titanium and aluminum, a composite carboxide containing titanium and aluminum, and a composite carbonitroxide containing titanium and aluminum, and (2) an aluminum oxide layer, at least one of the titanium-containing layer is coated on the surface of the base material and the aluminum oxide layer is coated on the surface of the titanium-containing layer, the titanium-containing layer adjacent to the aluminum oxide layer has a maximum surface roughness Rmax of 0.6 μm or less and an average surface roughness Ra of 0.2 μm or less in a reference length of 5 μm under conditions without being subjected to machining, the aluminum oxide layer has a maximum surface roughness Rmax of 0.7 μm or less and an average surface roughness Ra of 0.25 μm or less, and a thickness of the aluminum layer is 0.5 to 5 μm.

### DESCRIPTION OF THE PREFERRED EMBODIMENTS

In the embodiments of the present invention, a sintered alloy selected from a cemented carbide and cermet is used as a base material of the surface coated sintered alloy member. As the base material to be used in the present invention, there may be mentioned, for example, a base material comprising a hard phase and a binder phase. The hard phase of the hard alloy of the present invention comprises tungsten carbide as a main component and, as an auxiliary component, at least one material selected from the group consisting of carbides, nitrides and carbonitrides of a metal selected from the group consisting of the Group 4, 5 and 6 (IVa, Va and VIa) of the Periodic Table and mutual solid solutions thereof. The binder phase of the hard alloy comprises at least one element selected from the group consisting of Fe, Ni and Co. An amount of the binder phase is preferably 1 to 30% by weight based on the total amount of the hard alloy composition and the reminder is the hard phase. A maximum surface roughness Rmax and an average surface roughness Ra of the base material preferably have 1.5 μm or less and 0.5 μm or less, more preferably have 1.2 μm or less and 0.4 μm or less, particularly preferably have 0.9 μm or less and 0.3 μm or less, respectively, in the point of obtaining good chipping resistance as a cutting tool.

A hard film that is coated on the above-mentioned base material comprises at least one titanium-containing layer, preferably two or more titanium-containing layers. When the titanium-containing layer comprises two or more layers in a laminated structure, the compositions of the respective layers may be the same or different from each other. The respective titanium-containing layers to be used in the present invention comprise at least one material selected from the group consisting of titanium carbide, titanium nitride, titanium carbonitride, titanium carboxide, titanium nitroxide, titanium carbonitroxide, a composite nitride containing titanium and aluminum, a composite carbonitride containing titanium and aluminum, a composite nitroxide containing titanium and aluminum, a composite carboxide containing titanium and aluminum, and a composite carbonitroxide containing titanium and aluminum. Of these materials, preferably used materials are titanium carbide, titanium nitride, titanium carbonitride, titanium carboxide, and a composite carboxide containing titanium and aluminum.

A total thickness of the above-mentioned titanium-containing layer(s) is preferably in the range of 1 to 25 μm, more preferably in the range of 3.0 to 12.0 μm. When it is thinner than 1 μm, sufficient abrasion resistance cannot be obtained, and when it is thicker than 25 μm, tensile residual stress which is generated in the coating film is increased thereby leading to a poor chipping resistance.

The surface roughness of the above-mentioned titanium-containing layer is set to be a maximum surface roughness Rmax of 0.6 μm or less and an average surface roughness Ra of 0.2 μm or less with a reference length of 5 μm. When the surface roughnesses of the titanium-containing layer are within the above ranges, it has been found that the cutting performance is improved in an experiment in which chipping resistance in a region at high speed feeding was evaluated. Further, it is preferred that the surface of the titanium-containing layer has a smooth surface of Rmax of 0.15 μm or less and Ra of 0.05 μm or less since the cutting performance is much improved. Such surface roughnesses of the titanium-containing layer can be adjusted during a formation step of the titanium-containing layer.

In the present invention, the titanium-containing layer preferably includes therein a columnar crystal layer in a direction vertical to the surface of the base material. By controlling an average particle diameter of the columnar crystal (horizontal length of the columnar crystal) and a thickness of the columnar crystal layer (longitudinal length of the columnar crystal), the surface of the titanium-containing layer can be made smooth and flat.

An average particle diameter of the columnar crystal (horizontal length of the columnar crystal) is preferably in a range of 0.01 to 3.0 μm, more preferably in the range of 0.05 to 2.0 μm. When the average particle diameter is smaller than 0.01 μm, the abrasion resistance is lowered, and when the average particle diameter is larger than 3.0 μm, the titanium-containing layer cannot exhibit a desirable surface roughness.

The thickness of the columnar layer (longitudinal length of the columnar crystal) is preferably 2.0 μm to 20 μm, more preferably in the range of 3 to 12 μm. If the thickness of the columnar layer is less than 2.0 μm. a sufficient abrasion resistance sometimes cannot be obtained, while if the thickness of the columnar layer is more than 20 μm, tensile residual stress which is generated in the coating film is sometimes increased thereby leading to a poor chipping resistance.

The above mentioned columnar crystal layer is particularly preferably formed of titanium carbonitride.

In the present invention, it is more preferred that the titanium-containing layer contains titanium carbide, titanium carbonitride and titanium nitride, and contents of the titanium carbide, titanium carbonitride and titanium nitride are changed in an inclined structure from the base material surface to the surface of the hard film. More specifically, a nitrogen content in a part or whole of the titanium carbonitride is gradually decreased from the base material surface to the surface of the hard film while a carbon content is increased (TiN ->TiCN ->TiC), or else, a carbon content in apart or whole of the titanium carbonitride is gradually decreased from base material surface to the surface of the hard film while a nitrogen content is increased (TiC ->TiCN ->TiN).

In the second embodiment of the present invention, the hard film formed on a base material comprises (1) at least one titanium-containing layer and (2) an aluminum oxide layer coated on the titanium-containing layer. The base material and (1) the titanium-containing layer to be used in this embodiment are the same as that mentioned in the first embodiment. Thus, the total film thickness of (1) the titanium-containing layer is preferably in the range of 1 to 25 μm, and a maximum surface roughness Rmax and an average surface roughness Ra thereof adjacent to (2) the aluminum oxide layer are set to be 0.6 μm or less and 0.2 μm or less, respectively, as mentioned above. Also, (2) the aluminum oxide layer formed on (1) the titanium-containing layer is set to be a maximum surface roughness Rmax of 0.7 μm or less and an average surface roughness Ra of 0.25 μm or less. When the surface roughnesses of (1) the titanium-containing layer and those of (2) the aluminum oxide layer are within the above ranges, it has been found that the cutting performance is improved in an experiment (Example 1 mentioned below) in which chipping resistance in a region at high speed feeding was evaluated. Further, it is more preferred that the surface of (1) the titanium-containing layer has a smooth surface of Rmax of 0.15 μm or less and Ra of 0.05 μm or less and the surface of (2) the aluminum oxide layer has a smooth surface of Rmax of 0.3 μm or less and Ra of 0.1 μm or less, since the cutting performance can be much improved.

A thickness of (2) the aluminum oxide layer is preferably in the range of 0.5 to 5 μm, more preferably 1 to 3 μm . When the thickness of (2) the aluminum oxide layer is thinner than 0.5 μm, a desired abrasion resistance sometimes cannot be obtained, and when the thickness of (2) the aluminum oxide layer is thicker than 5 μm, the aluminum oxide layer itself performs particle growth so that the surface roughness of the aluminum oxide layer becomes coarse without maintaining the smoothness of the titanium-containing layer. Further, when the thickness of the aluminum oxide layer is in a more preferred range of 1 to 3 μm, the maximum surface roughness Rmax of the titanium-containing layer is substantially proportional to the maximum surface roughness Rmax of the aluminum oxide layer.

In the present invention, an intermediate layer comprising a titanium-containing compound may be further provided between (1) the titanium-containing layer and (2) the aluminum oxide layer. As such an intermediate layer, a layer comprising at least one selected from the group consisting of titanium carbide, titanium nitride, titanium carbonitride, titanium carboxide, titanium nitroxide, titanium carbonitroxide, a composite nitride containing titanium and aluminum, a composite carbonitride containing titanium and aluminum, a composite nitroxide containing titanium and aluminum, a composite carboxide containing titanium and aluminum, and a composite carbonitroxide containing titanium and aluminum, more preferably a layer comprising at least one selected from TiN, TiCO, TiAlCO and TiAlCNO, can be formed since these materials are excellent in adhesiveness to (1) the titanium-containing layer and (2) the aluminum oxide layer. A thickness of the intermediate layer is preferably in the range of 0.1 to 1 μm, more preferably in the range of 0.2 to 0.5 μm. If the intermediate layer is thinner than 0.1 μm, it sometimes cannot show an improved effect of adhesiveness, while if it is thicker than 1 μm, the abrasion resistance is sometimes lowered. The intermediate layer may be a single layer or a laminated layer of two or more layers.

Also, the average surface roughness Ra of the intermediate layer is substantially proportional to the average surface roughness Ra of the aluminum oxide layer. For example, when the surface roughness of the intermediate layer is Rmax=0.15 μm and Ra 0.05 μm the surface roughness of the aluminum oxide layer becomes Rmax=0.2 μm and Ra=0.07 μm, respectively.

In the present invention, a titanium-containing layer may further be provided on the aluminum oxide layer as an outermost layer, so that the cutting performance can be further improved. As a material for constituting the outermost titanium-containing layer, the above-mentioned materials for constituting the titanium-containing layer may be mentioned, preferably those comprising at least one material selected from the group consisting of titanium nitride, titanium carbonitride and titanium carbonitroxide, and titanium nitride is most preferably used.

A thickness of the outermost titanium-containing layer is preferably 0.001 to 1 μm , more preferably 0.01 to 0.5 μm and the surface roughness of the outermost titanium-containing layer is preferably Rmax of 0.3 μm or less and Ra of 0.1 μm or less. By providing the outermost titanium-containing layer on the aluminum oxide layer, the cutting characteristics of the cutting tool can be further improved. The outermost titanium-containing layer may be a single layer or a laminated layer of two or more layers.

The maximum surface roughness Rmax and the average surface roughness Ra in the reference length 5 μm of each surface of the titanium-containing layer and the aluminum oxide layer were obtained according to JIS 0601 (ISO468) provided that the reference length is made 5 μm as follows.

Vertical sections of samples are observed by SEM and a picture is taken in magnification of 10000 to 50000 times. A section curve of the interface between the aluminum oxide layer and the inner layer (1), a section curve of the interface between the aluminum oxide layer and the outermost layer (2) are obtained from the picture in a range of the reference length of 5 μm. The maximum surface roughness (Rmax) and the average surface roughness (Ra) are calculated from the section curves. When the section curve of the base material is not straight as in the case of the cutting edge of the cutting tool, it is necessary to measure Rmax and Ra excluding the curve which has resulted from a designed shape of the base material.

The reference length for obtaining the maximum surface roughness (Rmax) and the average surface roughness (Ra) was set to 5 μm because the smoothness with respect to the friction and abrasion in an extremely fine region is significantly reflected on the cutting performance in cutting at high speed feeding. Such a surface roughness of the titanium-containing layer is preferably adjusted in a step of forming the titanium-containing layer.

The following provides a more detailed explanation of the present invention through its examples.

### EXAMPLES

### Example 1

Each of the coating listed in Table 1 was applied to a cemented carbide base material corresponding to JIS standard P20.

The coating conditions of the various coating layers are as follows.

a) TiN(1) film preparation conditions 1173° K, 4×10⁵ Pa, TiCl₄—H₂—N₂ mixed gas

b) TiN(2) film preparation conditions 1273° K, 4×10⁵ Pa, TiCl₄—H₂—N₂ mixed gas

c) TiC film preparation conditions 1273° K, 1.9×10⁵ Pa, TiCl₄—H₂—CH₄ mixed gas

d) TiCN(1) film preparation conditions 1173° K, 8×10⁴ Pa, TiCl₄—Ar—CH₃ mixed gas

e) TiCN(2) film preparation conditions 1173° K, 1.9×10⁵ Pa, TiCl₄—H₂—N₂—C₂H₆ mixed gas

f) TiCN(3) film preparation conditions 1273° K, 1.9×10⁵ Pa, TiCl₄—H₂—N₂—CH₄ mixed gas

g) Al₂O₃ film preparation conditions 1273° K, 8×10⁴ Pa, AlCl₃—CO₂—H₂—H₂S mixed gas

TABLE 1
Sample contents

| | | | | | Surface | | | | | |
|---|---|---|---|---|---|---|---|---|---|---|
| | | | | | roughness of | | | Surface | | |
| | | | | Inter- | Ti-containing | | | roughness of | | |
| | | | | mediate | layer in | | Outside | outside layer | | Outermost |
| | | | | layer and | reference | | layer and | in reference | | layer and |
| | Ti-containing layer and film | | | film | length of 5 μm | | film | length of 5 μm | | film |
| | thickness (μm) | | | thickness | Rmax | Ra | thickness | Rmax | Ra | thickness |
| Number | layer 1 | layer 2 | layer 3 | (μm) | (μm) | (μm) | (μm) | (μm) | (μm) | (μm) |
| Example 1 | 1.1 TiN(1) | 7.3 TiCN(2) | | 0.7 TiN(2) | 0.12 | 0.03 | 2.0 Al₂O₃ | 0.24 | 0.08 | — |
| Example 2 | 1.0 TiN(1) | 4.5 TiCN(2) | 1.5 TiC | 0.7 TiN(2) | 0.30 | 0.10 | 2.0 Al₂O₃ | 0.30 | 0.10 | — |
| Example 3 | 0.5 TiN(1) | 5.0 TiCN(1) | 2.2 TiC | 0.7 TiN(2) | 0.32 | 0.11 | 1.5 Al₂O₃ | 0.32 | 0.11 | 0.1 TiN(2) |
| Example 4 | 1.0 TiN(1) | 4.5 TiCN(3) | 1.2 TiC | 0.8 TiN(2) | 0.35 | 0.12 | 2.0 Al₂O₃ | 0.40 | 0.13 | — |
| Example 5 | 1.1 TiN(1) | 6.6 TiCN(3) | | 0.7 TiN(2) | 0.36 | 0.12 | 2.0 Al₂O₃ | 0.40 | 0.13 | — |
| Example 6 | 1.1 TiN(1) | 5.2 TiCN(2) | 1.3 TiC | 0.2 TiCO | 0.42 | 0.14 | 2.0 Al₂O₃ | 0.43 | 0.14 | — |
| Example 7 | 1.2 TiN(1) | 7.1 TiCN(2) | | 0.2 TiCO | 0.44 | 0.14 | 2.0 Al₂O₃ | 0.45 | 0.15 | — |
| Example 8 | 0.3 TiN(1) | 4.3 TiCN(1) | 1.4 TiC | 0.2 TiN(2) | 0.44 | 0.15 | 1.0 Al₂O₃ | 0.46 | 0.16 | 0.2 TiN(2) |
| Example 9 | 0.3 TiN(1) | 7.3 TiCN(1) | | 0.7 TiN(2) | 0.55 | 0.18 | 2.0 Al₂O₃ | 0.56 | 0.19 | 0.3 TiN(2) |
| Comparative | 1.1 TiN(1) | 4.5 TiCN(3) | 1.4 TiC | 0.2 TiCO | 0.71 | 0.24 | 2.0 Al₂O₃ | 0.73 | 0.26 | 0.2 TiN(2) |
| example 1 | | | | | | | | | | |
| Comparative | 1.0 TiN(1) | 7.5 TiCN(3) | | 0.2 TiCO | 0.73 | 0.25 | 1.0 Al₂O₃ | 0.71 | 0.27 | — |
| example 2 | | | | | | | | | | |
| Comparative | 1.2 TiN(1) | 6.4 TiCN(3) | | 0.2 TiCO | 0.99 | 0.33 | 2.0 Al₂O₃ | 0.84 | 0.28 | — |
| example 3 | | | | | | | | | | |

TABLE 2
Results of cutting tests
Cutting conditions: S45C (U groove, four slots),
V = 100 m/min, d = 2.0 mm, dry, feeding up tests
Number of impacts at each feeding = 4000 times

| | Feeding | | | |
|---|---|---|---|---|
| | 0.30 | 0.35 | 0.40 | 0.45 |
| Number | mm/rev. | mm/rev. | mm/rev. | mm/rev. |
| Example 1 | ◯ | ◯ | ◯ | ◯ |
| Example 2 | ◯ | ◯ | ◯ | X |
| Example 3 | ◯ | ◯ | ◯ | X |
| Example 4 | ◯ | ◯ | ◯ | X |
| Example 5 | ◯ | ◯ | ◯ | X |
| Example 6 | ◯ | ◯ | ◯ | X |
| Example 7 | ◯ | ◯ | ◯ | X |
| Example 8 | ◯ | ◯ | ◯ | X |
| Example 9 | ◯ | ◯ | X | X |
| Comparative example 1 | X | XX | XX | XX |
| Comparative example 2 | X | XX | XX | XX |
| Comparative example 3 | XX | XX | XX | XX |

Mark: ∘Normal abrasion, X chipped on cutting edge, XX chipped

### Example 2

Each of coating listed in Table 3 was applied to a cemented carbide base material corresponding to JIS standard P20.

The coating conditions of various coating layers are the same as in Example 1.

TABLE 3
Sample contents

| | | | | | Surface | | | | | |
|---|---|---|---|---|---|---|---|---|---|---|
| | | | | | roughness of | | | Surface | | |
| | | | | Inter- | Ti-containing | | | roughness of | | |
| | | | | mediate | layer in | | Outside | outside layer | | Outermost |
| | | | | layer and | reference | | layer and | in reference | | layer and |
| | Ti-containing layer and film | | | film | length of 5 μm | | film | length of 5 μm | | film |
| | thickness (μm) | | | thickness | Rmax | Ra | thickness | Rmax | Ra | thickness |
| Number | layer 1 | layer 2 | layer 3 | (μm) | (μm) | (μm) | (μm) | (μm) | (μm) | (μm) |
| Example 10 | 1.1 TiN(1) | 7.3 TiCN(2) | | 0.7 TiN(2) | 0.12 | 0.03 | 2.0 Al₂O₃ | 0.24 | 0.08 | — |
| Example 11 | 1.0 TiN(1) | 7.1 TiCN(2) | 0.7 TiC(2) | 0.1 TiCO | 0.14 | 0.03 | 2.0 Al₂O₃ | 0.28 | 0.09 | — |
| Example 12 | 0.5 TiN(1) | 7.0 TiCN(2) | 0.8 TiN(2) | 0.1 TiAlCO | 0.15 | 0.04 | 1.5 Al₂O₃ | 0.29 | 0.09 | 0.1 TiN(2) |
| Example 13 | 1.1 TiN(1) | 6.6 TiCN(3) | — | 0.7 TiN(2) | 0.36 | 0.12 | 2.0 Al₂O₃ | 0.40 | 0.13 | — |
| Example 14 | 0.3 TiN(l) | 4.3 TiCN(1) | 1.4 TiC | 0.2 TiN(2) | 0.44 | 0.15 | 1.0 Al₂O₃ | 0.46 | 0.16 | 0.2 TiN(2) |
| Example 15 | 0.3 TiN(1) | 7.3 TiCN(2) | — | 0.7 TiN(2) | 0.55 | 0.18 | 2.0 Al₂O₃ | 0.56 | 0.19 | 0.3 TiN(2) |
| Comparative | 1.1 TiN(1) | 7.3 TiCN(2) | — | 0.7 TiN(2) | 0.72 | 0.28 | 0.1 Al₂O₃ | 0.12 | 0.03 | — |
| example 4 | | | | | | | | | | |
| Comparative | 1.1 TiN(1) | 6.6 TiCN(3) | — | 0.7 TiN(2) | 0.73 | 0.28 | 0.2 Al₂O₃ | 0.37 | 0.12 | — |
| example 5 | | | | | | | | | | |
| Comparative | 0.3 TiN(1) | 7.3 TiCN(1) | — | 0.7 TiN(2) | 0.72 | 0.32 | 0.2 Al₂O₃ | 0.56 | 0.19 | 0.3 TiN(2) |
| example 6 | | | | | | | | | | |
| Comparative | 1.1 TiN(1) | 7.3 TiCN(2) | — | 0.7 TiN(2) | 0.85 | 0.25 | 9.0 Al₂O₃ | 0.81 | 0.27 | — |
| example 7 | | | | | | | | | | |
| Comparative | 1.1 TiN(1) | 6.6 TiCN(3) | — | 0.7 TiN(2) | 0.84 | 0.29 | 9.2 Al₂O₃ | 0.82 | 0.28 | — |
| example 8 | | | | | | | | | | |
| Comparative | 0.3 TiN(1) | 7.3 TiCN(1) | — | 0.7 TiN(2) | 0.87 | 0.31 | 9,5 Al₂O₃ | 0.88 | 0.30 | 0.3 TiN(2) |
| example 9 | | | | | | | | | | |

TABLE 4
Results of cutting tests
Cutting conditions: S45C (U groove, four slots),
V = 100 m/min, d = 2.0 mm, dry, feeding up tests
Number of impacts at each feeding = 4000 times

| | Feeding | | | |
|---|---|---|---|---|
| | 0.30 | 0.35 | 0.40 | 0.45 |
| Number | mm/rev. | mm/rev. | mm/rev. | mm/rev. |
| Example 10 | ◯ | ◯ | ◯ | ◯ |
| Example 11 | ◯ | ◯ | ◯ | ◯ |
| Example 12 | ◯ | ◯ | ◯ | ◯ |
| Example 13 | ◯ | ◯ | ◯ | X |
| Example 14 | ◯ | ◯ | ◯ | X |
| Example 15 | ◯ | ◯ | ◯ | X |
| Comparative example 4 | Δ | Δ | XX | XX |
| Comparative example 5 | Δ | Δ | XX | XX |
| Comparative example 6 | Δ | XX | XX | XX |
| Comparative example 7 | X | XX | XX | XX |
| Comparative example 8 | X | XX | XX | XX |
| Comparative example 9 | XX | XX | XX | XX |

Mark: ∘Normal abrasion, X Chipped on cutting edge, XX Chipped, Δ Tool life terminated due to abrasion

### Example 3

Each of coating listed in Table 5 was applied by the chemical vapor deposition device to a cemented carbide base material corresponding to JIS standard P20. The coating conditions of various coating layers are the same as in Example 1.

By using the samples (Examples 15 to 17 and Comparative examples 10 to 12) shown in Table 5, fracture resistance cutting test was carried out under the conditions of S45C (U groove, four slots), cutting rate (V)=100 m/min, feed (d)=2.0 mm, dry, and feeding up. Number of impacts at each feeding was 4000 times.

The results are shown in Table 6.

TABLE 5

| | | | | | Surface roughness | |
|---|---|---|---|---|---|---|
| | | | | Outermost | of outermost layer | |
| | | | | layer and | in reference | |
| | Ti-containing layer and film | | | film | length of 5 μm | |
| | thickness (μm) | | | thickness | Rmax | Ra |
| Number | layer 1 | layer 2 | layer 3 | (μm) | (μm) | (μm) |
| Example 15 | 1.0 TiN(1) | 5.0 TiCN(2) | | 0.7 TiN(2) | 0.11 | 0.04 |
| Example 16 | 1.2 TiN(1) | 4.0 TiCN(2) | 1.2 TiC | 0.8 TiN(2) | 0.21 | 0.07 |
| Example 17 | 0.5 TiN(1) | 5.5 TiCN(2) | 1.5 TiC | 0.7 TiN(2) | 0.32 | 0.10 |
| Comparative | 1.0 TiN(1) | 5.0 TiCN(2) | | 0.1 TiN(2) | 0.82 | 0.27 |
| example 10 | | | | | | |
| Comparative | 1.2 TiN(1) | 4.0 TiCN(2) | | 1.2 TiC | 0.85 | 0.25 |
| example 11 | | | | | | |
| Comparative | 0.5 TiN(1) | 5.5 TiCN(2) | | 0.2 TiCO | 0.90 | 0.31 |
| example 12 | | | | | | |

TABLE 6

Feeding

| | 0.30 | 0.35 | 0.40 | 0.45 |
|---|---|---|---|---|
| | mm/rev. | mm/rev. | mm/rev. | mm/rev. |
| Example 15 | ◯ | ◯ | ◯ | ◯ |
| Example 16 | ◯ | ◯ | ◯ | ◯ |
| Example 17 | ◯ | ◯ | ◯ | ◯ |
| Comparative | | | | |
| example 10 | X | XX | XX | XX |
| Comparative | | | | |
| example 11 | X | XX | XX | XX |
| Comparative | | | | |
| example 12 | X | XX | XX | XX |

According to the surface coated sintered alloy member of the present invention, there have been attained the effect that the chipping resistance in cutting at a high speed feeding is extremely improved among various cutting properties, by introducing a titanium-containing layer having a smooth surface and an aluminum layer having a smooth surface, as compared with conventional coated sintered alloys and the coated sintered alloys outside the present invention, the effect of decreasing variations in the tool lives by a smooth surface of a hard film, the effect of making the quality of the alloy member stable, and the effects of making the production steps simple and short, reducing the production costs due to unnecessariness of machining after the formation of the hard film.

As described above, the surface coated sintered alloy member of the present invention exhibits excellent effects when it is used as a cutting tool represented by for example, turning tools, milling tools, drills, end mills and the like, particularly as an intermittent cutting tool and turning cutting tool where materials to be cut are cast irons or steels and which need the resistance to impact, as various cutting tools utilized under high speed feeding conditions and high load conditions, as a mold tool such as dice and punch, as a wear resisting tool such as cutting and shearing edges for example slitters, as a corrosion resisting and abrasion resistant tool such as nozzle and applying tools, and as a civil engineering tool typically including cutting tools, digging tools and drilling tools and pulverizing tools which are used in mines, road construction and civil engineering fields.

1. A surface coated sintered alloy member having a hard film coated on a base material of a sintered alloy selected from a cemented carbide and cermet, wherein the hard film comprises at least one titanium-containing layer and the respective titanium-containing layers comprise at least one material selected from the group consisting of titanium carbide, titanium nitride, titanium carbonitride, titanium carboxide, titanium nitroxide, titanium carbonitroxide, a composite nitride containing titanium and aluminum, a composite carbonitride containing titanium and aluminum, a composite nitroxide containing titanium and aluminum, a composite carboxide containing titanium and aluminum, and a composite carbonitroxide containing titanium and aluminum, and the uppermost titanium-containing layer has a smooth surface with a maximum surface roughness Rmax of 0.6 μm or less and an average surface roughness Ra of 0.2 μm or less in the reference length of 5 μm under conditions without being subjected to machining.

2. The surface coated sintered alloy member according to claim 1, wherein the titanium-containing layer comprises a single layer or a laminated layer of two or more layers each comprising at least one selected from the group consisting of titanium carbide, titanium nitride, titanium carbonitride, titanium carboxide, a composite carboxide containing titanium and aluminum, and a total thickness of the titanium-containing layer is 1 to 25 μm.

3. The surface coated sintered alloy member according to claim 1, wherein the surface roughness of the titanium-containing layer is adjusted in a step of forming the titanium-containing layer.

4. The surface coated sintered alloy member according to claim 1, wherein the titanium-containing layer includes a columnar crystal layer formed in a direction vertical to the surface of the base material.

5. The surface coated sintered alloy member according to claim 4, wherein the columnar crystal layer comprises columnar crystals of titanium carbonitride having an average diameter of 0.01 to 3.0 μm, and a thickness of the columnar layer is 2.0 to 20.0 μm.

6. The surface coated sintered alloy member according to claim 1, wherein the titanium-containing layer contains titanium carbide, titanium carbonitride and titanium nitride, and the contents of the titanium carbide, titanium carbonitride and titanium nitride are changed in an inclined structure from the base material surface to the surface of the hard film.

7. A surface coated sintered alloy member having a hard film coated on a base material of a sintered alloy selected from a cemented carbide and cermet, wherein the hard film comprises (1) at least one titanium-containing layer the respective layers of which comprise at least one material selected from the group consisting of titanium carbide, titanium nitride, titanium carbonitride, titanium carboxide, titanium nitroxide, titanium carbonitroxide, a composite nitride containing titanium and aluminum, a composite-carbonitride containing titanium and aluminum, a composite nitroxide containing titanium and aluminum, a composite carboxide containing titanium and aluminum, and a composite carbonitroxide containing titanium and aluminum, and (2) an aluminum oxide layer, at least one of the titanium-containing layer is coated on the surface of the base material and the aluminum oxide layer is coated on the surface of the titanium-containing layer, the titanium-containing layer adjacent to the aluminum oxide layer has a maximum surface roughness Rmax of 0.6 μm or less and an average surface roughness Ra of 0.2 μm or less in a reference length of 5 μm under conditions without being subjected to machining, the aluminum oxide layer has a maximum surface roughness Rmax of 0.7 μm or less and an average surface roughness Ra of 0.25 μm or less, and a thickness of the aluminum oxide layer is 0.5 to 5 μm.

8. The surface coated sintered alloy member according to claim 7, wherein the titanium-containing layer comprises a single layer or a laminated layer of two or more layers each comprising at least one selected from the group consisting of titanium carbide, titanium nitride, titanium carbonitride, titanium carboxide, a composite carboxide containing titanium and aluminum, and a total thickness of the titanium-containing layer is 1 to 25 μm.

9. The surface coated sintered alloy member according to claim 7, wherein the surface roughness of the titanium-containing layer is adjusted in a step of forming the titanium-containing layer.

10. The surface coated sintered alloy member according to claim 7, wherein the titanium-containing layer includes a columnar crystal layer formed in a direction vertical to the surface of the base material.

11. The surface coated sintered alloy member according to claim 10, wherein the columnar crystal layer comprises columnar crystals of titanium carbonitride having an average diameter of 0.01 to 3.0 μm and a thickness of the columnar layer is 2.0 to 20.0 μm.

12. The surface coated sintered alloy member according to claim 7, wherein the titanium-containing layer contains titanium carbide, titanium carbonitride and titanium nitride, and the contents of the titanium carbide, titanium carbonitride and titanium nitride are changed in an inclined structure from the base material surface to the surface of the hard film.

13. The surface coated sintered alloy member according to claim 7, wherein an intermediate layer is further formed between the titanium-containing layer and the aluminum oxide layer and comprises at least one material selected from the group consisting of titanium nitride, titanium carboxide, titanium nitroxide, titanium carbonitroxide, a composite nitride containing titanium and aluminum, a composite carbonitride containing titanium and aluminum, a composite nitroxide containing titanium and aluminum, a composite carboxide containing titanium and aluminum and a composite carbonitroxide containing titanium and aluminum, and a thickness of the intermediate layer is 0.1 to 1 μm.

14. The surface coated sintered alloy member according to claim 7, wherein at least one outermost layer comprising at least one material selected from the group consisting of titanium nitride, titanium carbonitride and titanium carbonitroxide is formed on the surface of the aluminum oxide layer.

15. The surface coated sintered alloy member according to claim 1, wherein the surface coated sintered alloy member is used as a tool.

16. The surface coated sintered alloy member according to claim 15, wherein the tool is a cutting tool.

17. The surface coated sintered alloy member according to claim 7, wherein the surface coated sintered alloy member is used as a tool.

18. The surface coated sintered alloy member according to claim 17, wherein the tool is a cutting tool.
